(19) United States
(12) Patent Application Publication
(10) Pub. No.: US 2026/0138449 A1
(43) Pub. Date: May 21, 2026

(54) INFORMATION PROVISION SYSTEM, INFORMATION PROVISION METHOD, AND STORAGE MEDIUM

(71) Applicant: HONDA MOTOR CO., LTD., Tokyo (JP)

(72) Inventors: Yuichiro Shimura, Wako-shi (JP); Toshihiro Hashimoto, Wako-shi (JP); Haruko Okuyama, Wako-shi (JP); Tsuyoshi Nojiri, Wako-shi (JP); Tatsuya Iwasa, Wako-shi (JP)

(21) Appl. No.: 19/380,086

(22) Filed: Nov. 5, 2025

(30) Foreign Application Priority Data
Nov. 15, 2024 (JP) 2024-199827

(51) Int. Cl. B60K 35/26; B60K 35/29

(52) U.S. Cl. CPC B60K 35/265; B60K 35/29; B60K 2360/178; B60K 2360/741

(57) ABSTRACT

An information provision system includes: a user state recognition unit that recognizes a state of a user in a mobile body; a user emotion estimation unit that estimates an emotional level of the user based on a predetermined index value, based on a recognition result of the state of the user; and an agent control unit that provides, using an anthropomorphic agent, the user with an HMI that performs speech output in a mode corresponding to an emotional level of the agent based on the predetermined index value. The agent control unit controls the emotional level of the agent to be a target level for changing the emotional level of the user to fall outside of a predetermined determination range, when the emotional level of the user estimated by the user emotion estimation unit falls within the predetermined determination range.

### INCORPORATION BY REFERENCE

The present application claims priority under 35 U.S.C. § 119 to Japanese Patent Application No. 2024-199827 filed on Nov. 15, 2024. The content of the application is incorporated herein by reference in its entirety.

### BACKGROUND OF THE INVENTION

### Field of the Invention

The present invention relates to an information provision system, an information provision method, and a storage medium.

### Description of the Related Art

In recent years, technology has been proposed to equip a human machine interface (HMI) of an information provision apparatus used in a mobile body such as a vehicle with an anthropomorphic agent that communicates with a user. For example, Japanese Patent Laid-Open No. 2022-038423 discloses a technique of estimating an emotion of a driver of a vehicle, and when the emotion of the driver emotion is negative, i.e., not desiring a response from others, response content is output that can change the emotion of the driver to a negative emotion at a predetermined level or lower or to a positive emotion according to a level of the negative emotion. Japanese Patent Laid-Open No. 2018-206198 discloses a technique of starting output of interactive speech when a decrease in alertness of the driver is detected and stopping the output of the interactive speech when recovery from the decrease in alertness of the driver is detected.

When issuing a warning for avoiding a risk, such as contact between the vehicle and an obstacle, through speech output for the driver by an HMI agent via a driving assistance function included in the vehicle, it is conceivable to change a mode of the speech output by the agent to enhance effectiveness of the warning. However, based on the principles of behavioral imitation, emotional contagion, and the like, actions (utterance speed and the like), emotions, and the like of the agent with whom the driver is interacting are unconsciously imitated (operation speed and the like) by and spread to the driver. Therefore, depending on the output mode of the warning speech by the agent, a change in the emotion of the driver after receiving the warning may lead to excessive caution, insufficient caution, or the like by the driver.

Therefore, an object of the present application is to provide an information provision system that can suppress excessive caution, insufficient caution, or the like, when issuing a warning via the HMI using the agent to the user riding the vehicle. The above technique contributes to further improving traffic safety and development of a sustainable transportation system.

### SUMMARY OF THE INVENTION

As a first aspect for achieving the above object, an information provision system includes: a user state recognition unit that recognizes a state of a user in a mobile body; a user emotion estimation unit that estimates an emotional level of the user based on a predetermined index value, based on a recognition result of the state of the user by the user state recognition unit; and an agent control unit that provides, using an anthropomorphic agent, the user with a human machine interface (HMI) that performs speech output in a mode corresponding to an emotional level of the agent based on the predetermined index value, wherein the agent control unit controls the emotional level of the agent to be a target level for changing the emotional level of the user to fall outside of a predetermined determination range, when the emotional level of the user estimated by the user emotion estimation unit falls within the predetermined determination range.

The above information provision system may further include a risk recognition unit that recognizes a predetermined risk faced by the mobile body, wherein the agent control unit may set the determination range according to the predetermined risk, when the predetermined risk is recognized by the risk recognition unit.

In the above information provision system, the predetermined index value may represent valence indicating comfort and discomfort, and the agent control unit may control the emotional level of the agent to be the target level by modifying a basic frequency or a fluctuation width of speech output by the agent, when the emotional level of the user estimated by the user emotion estimation unit falls within the predetermined determination range.

In the above information provision system, the predetermined index value may represent valence indicating comfort and discomfort, and the agent control unit may control the emotional level of the agent to be the target level by causing an inflection of an utterance output by the agent to go up or go down, when the emotional level of the user estimated by the user emotion estimation unit falls within the predetermined determination range.

In the information provision system, the predetermined index value may represent arousal indicating excitement and calmness, and the agent control unit may control the emotional level of the agent to be the target level by modifying an utterance speed or a sound volume of speech output by the agent, when the emotional level of the user estimated by the user emotion estimation unit falls within the predetermined determination range.

As a second aspect for achieving the above object, an information provision method executed by a computer includes: a user state recognition step of recognizing a state of a user in a mobile body; a user emotion estimation step of estimating an emotional level of the user based on a predetermined index value, based on a recognition result of the state of the user in the user state recognition step; and an agent control step of providing, using an anthropomorphic agent, the user with a human machine interface (HMI) that performs speech output in a mode corresponding to an emotional level of the agent based on the predetermined index value, wherein in the agent control step, the emotional level of the agent is controlled to be a target level for changing the emotional level of the user to fall outside of a predetermined determination range, when the emotional level of the user estimated in the user emotion estimation step falls within the predetermined determination range.

As a third aspect for achieving the above object, a non-transitory computer-readable storage medium storing a program causes a computer to functions as: a user state recognition unit that recognizes a state of a user in a mobile body; a user emotion estimation unit that estimates an emotional level of the user based on a predetermined index value, based on a recognition result of the state of the user by the user state recognition unit; and an agent control unit that provides, using an anthropomorphic agent, the user with a human machine interface (HMI) that performs speech output in a mode corresponding to an emotional level of the agent based on the predetermined index value, wherein the agent control unit controls the emotional level of the agent to be a target level for changing the emotional level of the user to fall outside of a predetermined determination range, when the emotional level of the user estimated by the user emotion estimation unit falls within the predetermined determination range.

According to the information provision system, the information provision method, and the storage medium described above, it is possible to suppress excessive caution, insufficient caution, or the like, when issuing a warning via the HMI using the agent to the user in the mobile body.

### BRIEF DESCRIPTION OF THE DRAWINGS

FIG. 1 is an explanatory diagram of a use mode of an information provision system;

FIG. 2 is a configuration diagram the information provision system;

FIG. 3 is an explanatory diagram of an emotion map based on valence and arousal;

FIG. 4 is an explanatory diagram of properties of each region in the emotion map;

FIG. 5 is an explanatory diagram of parameters for changing the valence and the arousal;

FIG. 6 is a first explanatory diagram of parameters for changing characteristics of a voice;

FIG. 7 is a second explanatory diagram of parameters for changing the characteristics of the voice;

FIG. 8 is a flowchart of emotion control processing of an agent; and

FIG. 9 is an explanatory diagram of a control mode of an emotional level of the agent.

### DETAILED DESCRIPTION OF THE INVENTION

### 1. Use Mode of Information Provision System

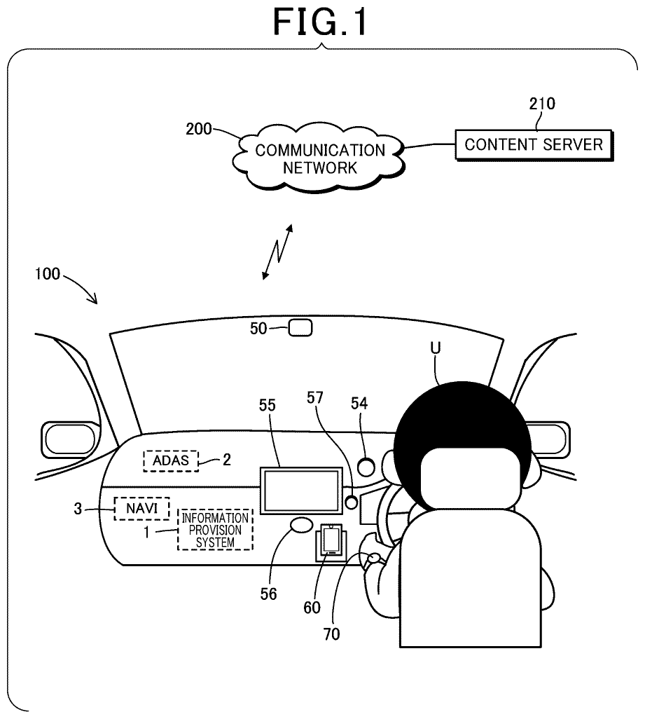

A use mode of an information provision system 1 according to the present embodiment will be described with reference to FIG. 1. The information provision system 1 provides a user U being a driver of a vehicle 100 with a human machine interface (HMI) using an agent with anthropomorphic emotions. The information provision system 1 may be configured as part of functions of an in-vehicle device such as a navigation apparatus installed in the vehicle 100, or may be configured as a dedicated in-vehicle device. The vehicle 100 corresponds to a mobile body of the present disclosure.

The information provision system 1 has a communication function, and performs wireless communication between a wearable device 70 (smartwatch or the like) worn by the user U and a mobile terminal 60 (smartphone, tablet terminal, mobile phone, or the like) brought into the vehicle 100 by the user U. The information provision system 1 performs communication with a vehicle-exterior communication system, such as a content server 210, via a communication network 200.

The vehicle 100 includes a driver monitor camera 54 that captures the user U, a touch panel display 55, a speaker 56, a microphone 57 that collects an utterance of the user U, a front camera 50 that captures an area in front of the vehicle 100, an advanced driver-assistance system (ADAS) 2 that performs various driving assistance control based on an image captured by the front camera 50, and a navigation apparatus 3 that performs route guidance to a destination.

The agent installed in the information provision system 1 is, for example, an interface agent including an artificial intelligence (AI) program. The agent is an interactive interface that analyzes the speech of the user U input to the microphone 57 through speech recognition, and outputs information through speech output from the speaker 56 or through image display on the display 55 according to utterance content. The agent, depending on an utterance of the user U, suggests a destination via the route guidance of the navigation apparatus 3, suggests content to be downloaded from the content server 210 and played, and provides a warning and the like about a predetermined risk (approaching obstacle or the like) recognized by the ADAS 2.

The information provision system 1 estimates an emotion of the user U based on the image of the user U captured by the driver monitor camera 54, the speech of the user U input to the microphone 57, and the biological information (heart rate, body temperature, blood pressure, and the like) of the user U detected by the wearable device 70.

The information provision system 1 sets the emotion of the agent based on the emotion of the user U, and the agent controls a mode of the speech output from the speaker 56 (utterance content, intonation, pitch, sound volume, and the like) according to the set emotion. As will be described in detail below, the information provision system 1 performs control of changing an emotional level of the agent according to an emotional level of the user U, in order to make the warning for the user U more appropriate.

### 2. Configuration of Information Provision System

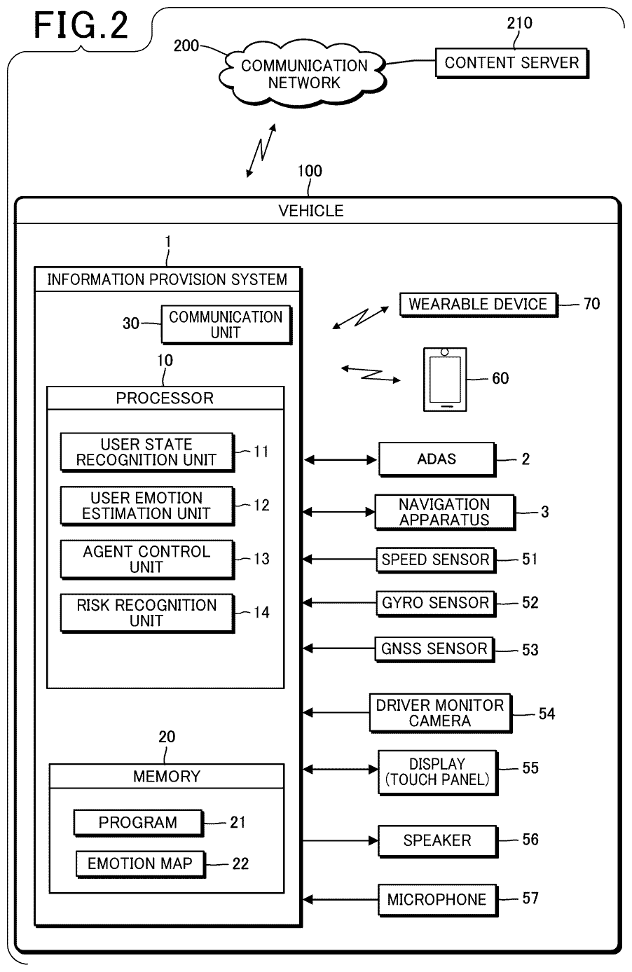

A configuration of the information provision system 1 will be described with reference to FIGS. 2 to 7. With reference to FIG. 2, the information provision system 1 is a control unit including a processor 10, a memory 20, a communication unit 30, and the like. The information provision system 1 is connected to the ADAS 2, a speed sensor 51, a gyro sensor 52, a global navigation satellite system (GNSS) sensor 53, the driver monitor camera 54, the display 55, the speaker 56, and the microphone 57 installed in the vehicle 100.

The communication unit 30 includes a transmitter and a receiver and performs short-range wireless communication between the mobile terminal 60 and the wearable device 70 in accordance with a specification such as Bluetooth (registered trademark) or ultra wideband (UWB). The communication unit 30 performs communication with the content server 210 via the communication network 200.

The memory 20 stores a program 21 for control of the information provision system 1, emotion map 22 data, and the like. The emotion map 22 will be described in detail below. The processor 10 functions as a user state recognition unit 11, a user emotion estimation unit 12, an agent control unit 13, and a risk recognition unit 14, by loading and executing the program 21.

Processing executed by the user state recognition unit 11 corresponds to a user state recognition step in an information provision method of the present disclosure, and processing executed by the user emotion estimation unit 12 corresponds to a user emotion estimation step in the information provision method of the present disclosure. Processing executed by the agent control unit 13 corresponds to an agent control step in the information provision method of the present disclosure.

The user state recognition unit 11 recognizes the state of the user U based on at least one of information input by a touch operation on the display 55, the image of the user U captured by the driver monitor camera 54, the speech of the user U input to the microphone 57, and the biological information of the user U detected by the wearable device 70, as a state of the user U in the vehicle 100.

The user state recognition unit 11 recognizes, for example, the following elements as the state of the user U.

First element: response to an inquiry “How are you feeling today?” or the like displayed on the display 55 when the user U gets in the vehicle 100, the response being input via a touch operation on the display 55.

Second element: expression and behavior of the user U recognized from the image of the user U.

Third element: utterance content, intonation, pitch, and sound volume of the speech of the user U.

Fourth element: biological information of the user U (heart rate, blood pressure, body temperature, and the like).

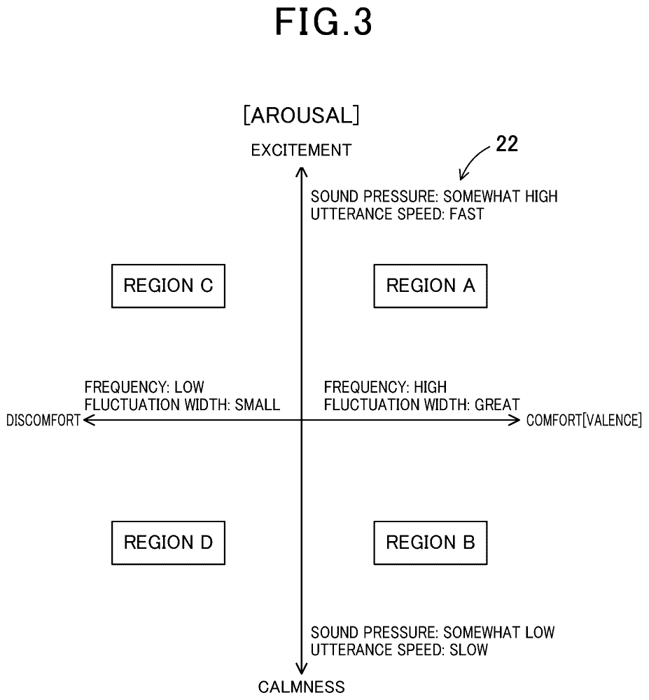

The user emotion estimation unit 12 estimates the emotional level of the user U based on the state of the user U recognized by the user state recognition unit 11. The user emotion estimation unit 12 estimates valence and arousal of the user U via the emotion map 22 shown in FIG. 3 as index values of the emotional level. Valence is an index value indicating a level of discomfort/comfort of the user U, and arousal is an index value indicating a level of excitement/calmness of the user U. Valence and arousal correspond to predetermined index values of the present disclosure.

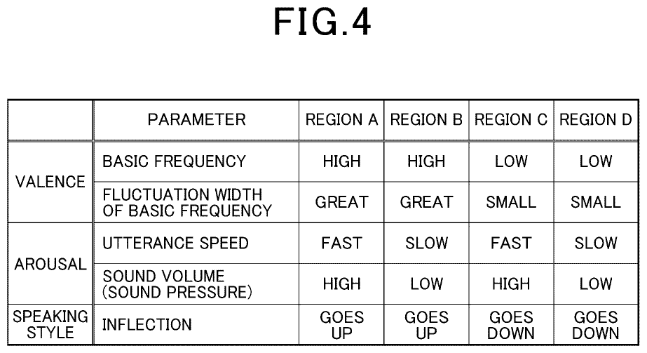

As shown in FIG. 4, in a region A, a region B, a region C, and a region D segmented by the valence and arousal axes in the emotion map 22, basic frequency and a fluctuation width of the basic frequency being parameters of valence, utterance speed and sound pressure (sound volume) being parameters of arousal, and inflection going up/down being a parameter of speaking style differ for the speech.

The user emotion estimation unit 12 estimates, for example, the emotion of the user U by setting the valence and arousal levels as follows, based on the above first to fourth elements.

Regarding the above first element, the user emotion estimation unit 12 sets the valence of the user U to a relatively high value (for example, 3 on a scale of ±10) when the response to the inquiry is “same as usual,” but sets the arousal to a relatively low value (for example, −3 on a scale of ±10) when the response to the inquiry is “different than usual.”

Regarding the above second element, the user emotion estimation unit 12, based on the expression of the user U, sets the valence to a relatively high value (for example, 5 on a scale of ±10) when it is determined that the user U is showing a smiling expression, but sets the valence to a relatively low value (for example, −5 on a scale of ±10) when it is determined that the user U is showing an annoyed expression. The user emotion estimation unit 12, based on the behavior of the user U, sets the arousal to a relatively high value (for example, 3 on a scale of ±10) when it is determined that the user U is moving restlessly, but sets the arousal to a relatively low value (for example, −3 on a scale of ±10) when it is determined that the user U is hardly moving.

Regarding the above third element, the user emotion estimation unit 12, based on the utterance content of the user U, sets the valence to a relatively high value (for example, 5 on a scale of ±10) when it is determined that the utterance is positive in content such as complimenting something or expecting something positive, but sets the valence to a relatively low value (for example, −5 on a scale of ±10) when it is determined that the utterance is negative in content such as criticizing something. When a specific keyword is included in the content of statements of the user U (such as “good” or “really good”), the user emotion estimation unit 12 sets the valence and arousal values associated with the keyword.

The user emotion estimation unit 12, based on a pitch of the speech of the user U, for example, sets the arousal to a relatively high value (for example, 3 on a scale of ±10) when the pitch of the speech of the user U is higher than or equal to a predetermined pitch, but sets the arousal to a relatively low value (for example, −3 on a scale of ±10) when the pitch of the speech of the user U is lower than the predetermined pitch.

Regarding the fourth element, the user emotion estimation unit 12 applies detected values of the biological information of the user U (heart rate, blood pressure, body temperature, and the like) to a correspondence table of detected values, valence, and arousal prepared in advance, and sets the valence and arousal. The correspondence table may be created based on a profile of the user U input by user U, the biological information of the user U detected in the past, and the like.

The user emotion estimation unit 12 may recognize the valence and arousal values based on a change in a traveling speed of the vehicle 100 detected by the speed sensor 51, a behavior of the vehicle 100 detected by the gyro sensor 52, a variation in a traveling position of the vehicle 100 detected by the GNSS sensor 53, and the like. The user emotion estimation unit 12 may estimate the emotion of the user U based on one of the valence or the arousal, or based on another index value.

The agent control unit 13 provides the user U with the HMI via the agent with anthropomorphic emotions. The agent control unit 13 analyzes the utterance of the user U input to the microphone 57, and outputs a response to the utterance by outputting the speech of the agent from the speaker 56 or through the image display of the agent on the display 55. The agent control unit 13 changes the emotion of the agent depending on the emotion of the user U estimated by the user emotion estimation unit 12, and modifies the output mode of the speech of the agent output from the speaker 56 (intonation, pitch, sound volume, and the like) according to the emotion of the agent.

The agent control unit 13 controls the emotional level of the agent by using the basic frequency (key), the fluctuation width of the basic frequency, the utterance speed, the sound volume (sound pressure), and text content as parameters for modifying the emotional expression of the speech output by the agent in order to change these parameters in combination.

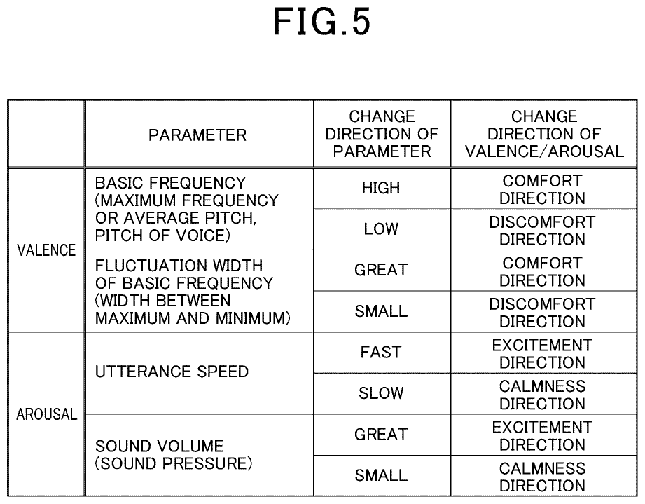

Here, FIGS. 5 to 7 exemplify conditions under which the emotional expression of the output speech by the agent is modified by changing the above parameters.

First, FIG. 5 shows control conditions that depend on changing the basic frequency, an oscillation amplitude of the basic frequency, the utterance speed, and the sound volume (sound pressure). As shown in FIG. 5, the agent control unit 13 controls the valence in a comfort direction by increasing the basic frequency or by increasing the oscillation amplitude of the basic frequency. The agent control unit 13 controls the valence in a discomfort direction by decreasing the basic frequency or by decreasing the oscillation amplitude of the basic frequency.

Furthermore, as shown in FIG. 5, the agent control unit 13 controls the arousal in an excitement direction by increasing the utterance speed or by increasing the sound volume. The agent control unit 13 controls the arousal in a calmness direction by decreasing the utterance speed or by decreasing the sound volume (sound pressure).

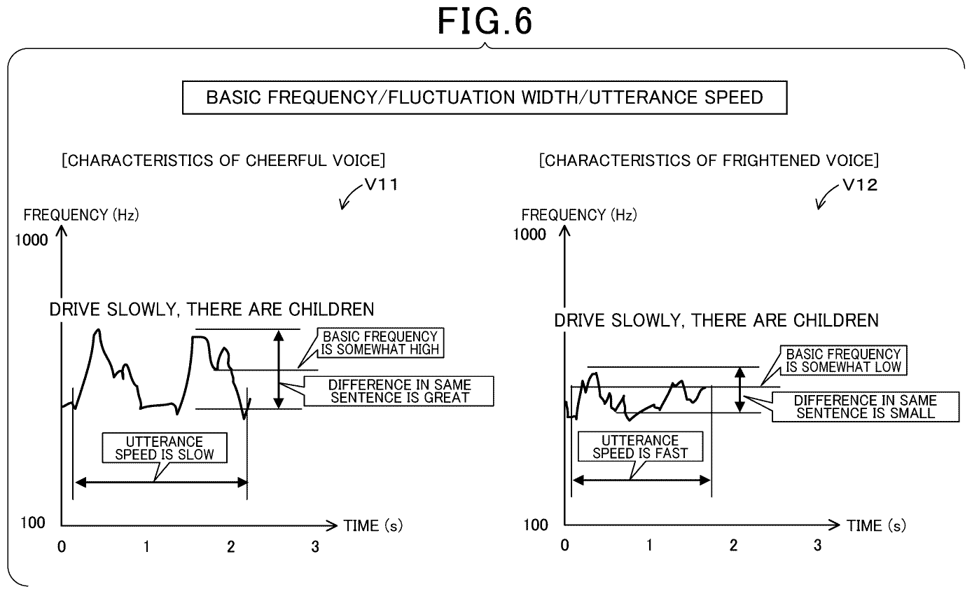

Next, FIG. 6 shows control conditions that depend on changing the basic frequency, the fluctuation width of the basic frequency, and the utterance speed. In FIG. 6, an utterance text “drive slowly, there are children” is denoted by V11 when output with a cheerful voice and denoted by V12 when output with a frightened voice. In V11 and V12, a horizontal axis is set to time and a vertical axis is set to frequency.

In V11, the parameters are set as follows.
Basic frequency: somewhat high
Fluctuation width of basic frequency: large
Utterance speed: slow

In V12, the parameters are set as follows.
Basic frequency: somewhat low
Fluctuation width of basic frequency: small
Utterance speed: fast

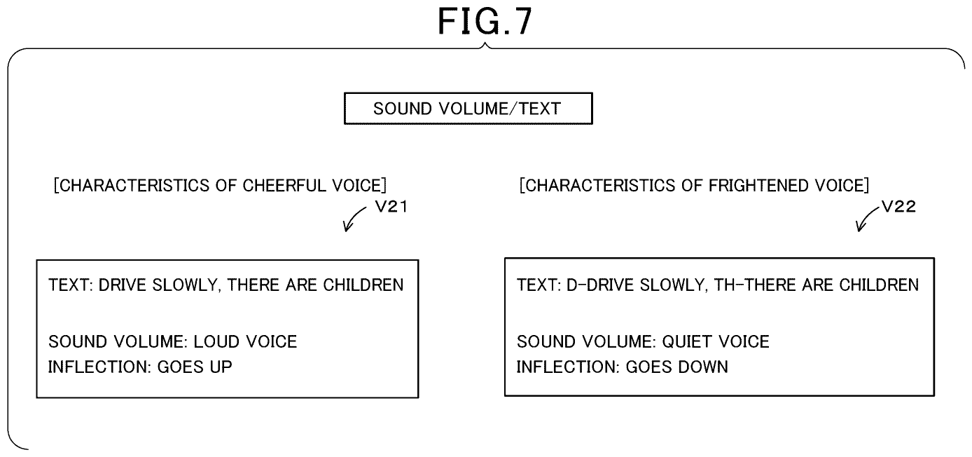

Next, FIG. 7 shows control conditions that depend on changing the sound volume and the text content. In FIG. 7, the utterance text is denoted by V21 when output with a cheerful voice and denoted by V22 when output with a frightened voice.

In V21, the parameters are set as follows.
Utterance text: “drive slowly, there are children”
Sound volume: high
Inflection: goes up

In V22, the parameters are set as follows.
Utterance text: “d-drive slowly, th-there are children”
Sound volume: low
Inflection: goes down

The risk recognition unit 14 recognizes the predetermined risk faced by the vehicle 100 based on risk information input from the ADAS 2. An example of the predetermined risk faced by the vehicle 100 includes, for example, an approaching monitoring target (other vehicle, pedestrian, obstacle, or the like) present in a vicinity of the vehicle 100. As a distance between the vehicle 100 and the monitoring target decreases, a degree of the risk recognized by the risk recognition unit 14 increases. Note that the risk recognition unit 14 may recognize a degree of concentration of the user U on driving from a facial image of the user U captured by the driver monitor camera 54, the biological information of the user U detected by the wearable device 70, and the like, and may recognize a state in which the degree of concentration has decreased to or below a predetermined level as the predetermined risk.

Note that the risk recognition unit 14 may detect a target, detect a relative position thereof, and the like by using a front camera, using communication by an inter-vehicle communication apparatus, a GNSS unit, or V2X (communication between road and vehicle or between pedestrians, and the like), or using determination in a virtual environment via a server, thereby calculating the degree of the risk.

### 3. Emotion Control Processing of Agent

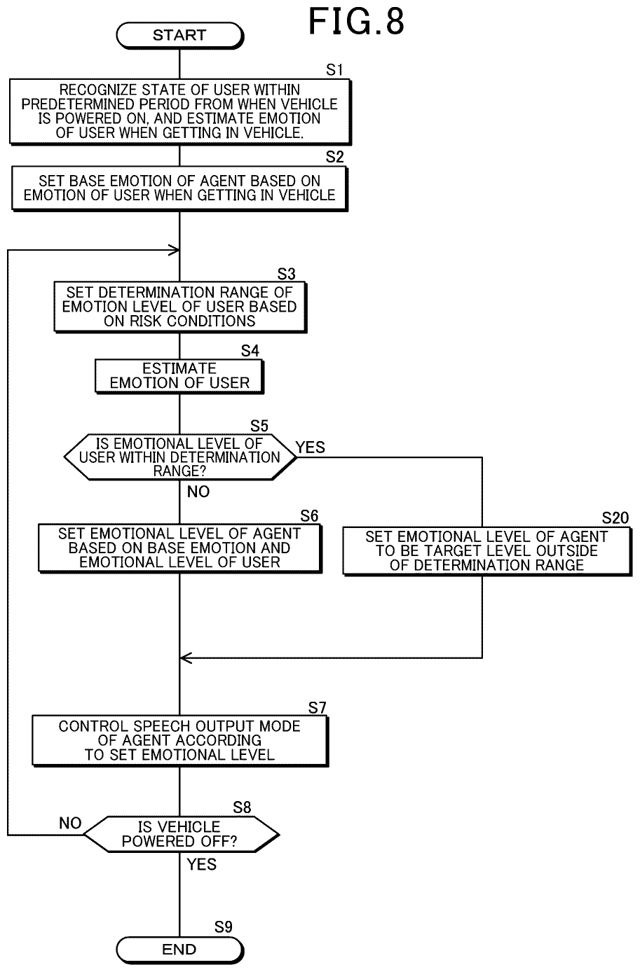

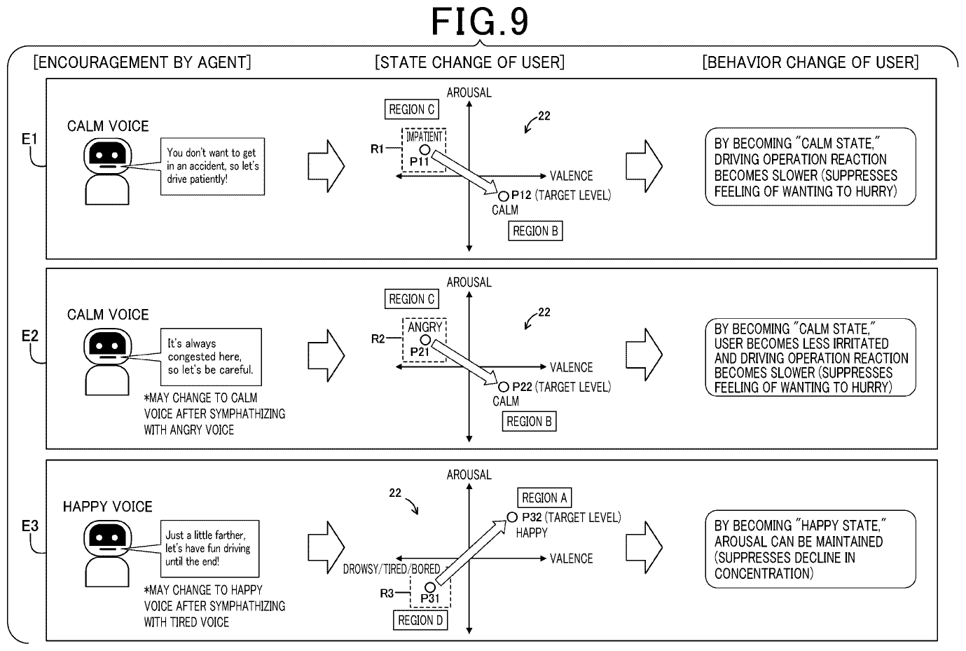

A procedure of emotion control processing of the HMI agent executed by the information provision system 1 according to a flowchart shown in FIG. 8 will be described with reference to FIG. 9. When it is recognized that the user U gets in and powers on the vehicle 100, the information provision system 1 starts the processing according to the flowchart shown in FIG. 8.

In step S1 of FIG. 8, the user emotion estimation unit 12 estimates the emotion of the user U within a predetermined period from when the user U gets in the vehicle, based on the state of the user U recognized by the user state recognition unit 11 within the predetermined period. Next, in step S2, the agent control unit 13 sets a base emotion being a baseline of the emotion set for the agent, based on the emotion of the user U estimated by the user emotion estimation unit 12 in step S1.

Next, in step S3, the agent control unit 13 sets a determination range of the emotional level of the user U based on conditions of the risk recognized by the risk recognition unit 14. Here, FIG. 9 exemplifies a mode in which the emotional level of the agent is controlled so that the emotion of the user U falls outside of the determination range, when the emotional level of the user U estimated by the user emotion estimation unit 12 falls within the determination range of the emotional level set according to the conditions of the risk.

In FIG. 9, E1 indicates a case in which the emotional level of the user U is at P11 within a determination range R1 indicating “impatient” in region C of the emotion map 22, E2 indicates a case in which the emotional level of the user U is at P21 within a determination range R2 indicating “angry” in region C of the emotion map 22, and E3 indicates a case in which the emotional level of the user U is at P31 within a determination range R3 indicating “drowsy/tired/bored” in region D of the emotion map 22.

The agent control unit 13, for example, sets the determination range R1 when the vehicle 100 is recognized by the risk recognition unit 14 to be traveling at high speed, sets the determination range R2 when the vehicle 100 is recognized by the risk recognition unit 14 to be traveling on a congested road, and sets the determination range R3 when the arousal of the user U is recognized by the risk recognition unit 14 to be lower than or equal to the predetermined level.

In step S4, the user emotion estimation unit 12 estimates the emotional level of the user U based on the state of the user U recognized by the user state recognition unit 11. Next, in step S5, the agent control unit 13 determines whether the emotional level of the user U falls within the determination range. The agent control unit 13 then proceeds the processing to step S20 when the emotional level of the user U is within the determination range, and proceeds the processing to step S6 when the emotional level of the user U falls outside of the determination range.

In step S20, the agent control unit 13 sets the emotional level of the agent to a target level outside of the determination range, and proceeds the processing to step S7. In step S6, the agent control unit 13 sets the emotional level of the agent based on the base emotion set in step S2 and the emotion of the user U estimated in step S4, and proceeds the processing to step S7. In step S7, the agent control unit 13 controls the mode of the speech output of the agent according to the emotional level set in step S6 or step S20.

Here, in E1 of FIG. 9, the target level of the emotional level of the agent is set to P12 corresponding to “calm” in the region B outside of the determination range R1, and a calm voice stating “you don't want to get in an accident, so let's drive patiently!” is output via the speech of the agent. With this, based on the principles of behavioral imitation, the emotion of the user U is expected to change to a calm state to emulate the emotion of the agent. By changing the emotion of the user U to a “calm state,” a driving operation reaction of the user U becomes slower, making it possible to suppress the feeling of the user U to hurry.

In E2 of FIG. 9, the target level of the emotion of the agent is set to P22 corresponding to “calm” in the region B outside of the determination range R2, and a calm voice stating “it's always congested here, so let's be careful” is output via the speech of the agent. With this, based on the principles of behavioral imitation, the emotion of the user U is expected to change to a calm state to emulate the emotion of the agent. By changing the emotion of the user U to a “calm state,” the user U becomes less irritated and the driving operation reaction of the user U becomes slower, making it possible to suppress the feeling of the user U to hurry.

Note that the speech output of the agent with a calm voice may be changed to the setting in which the emotion of the agent corresponds to “calm,” after expressing sympathy, empathy, or the like towards the user U using the speech output of the agent with an angry voice as the setting in which the emotion of the agent corresponds to “angry.”

In E3 of FIG. 9, the target level of the emotion of the agent is set to P32 corresponding to “happy” in the region A outside of the determination range R3, and a happy voice stating “just a little farther, let's have fun driving until the end” is output via the speech of the agent. With this, based on the principles of behavioral imitation, the emotion of the user U is expected to change to a happy state to emulate the emotion of the agent. By changing the emotion of the user U to a “happy state,” the arousal of the user U is maintained, making it possible to suppress a decline in the concentration of the user U.

Note that the speech output of the agent with a happy voice may be changed to the setting in which the emotion of the agent corresponds to “happy,” after expressing sympathy, empathy, or the like towards the user U using the speech output of the agent with a tired voice as the setting in which the emotion of the agent corresponds to “tired.”

Next, in step S8, the agent control unit 13 determines whether the vehicle 100 has been powered off. When the vehicle 100 has not been powered off, the agent control unit 13 then proceeds the processing to step S3 and executes the processing in steps S3 to S8 and S20 again. On the other hand, when the vehicle 100 has been powered off, the agent control unit 13 proceeds the processing to step S9 and ends the emotion control processing of the agent.

### 4. Other Embodiments

In the above embodiment, the vehicle 100 is shown as the mobile body of the present disclosure, but the mobile body of the present disclosure may be an aircraft, a ship, or the like as long as the vehicle 100 is a mobile body that provides the HMI using the agent to the user in the vehicle 100.

In the above embodiment, the information provision system of the present disclosure is exemplified as the information provision system 1 configured as an in-vehicle device installed in the vehicle 100. As another embodiment, part or all of the information provision system of the present disclosure may be configured as the mobile terminal 60 brought into the vehicle 100, or as an external communication system such as the content server 210 outside of the vehicle 100.

When configuring the information provision system as the mobile terminal 60, it is possible to provide the HMI utilizing the agent by using a camera, a microphone, a speaker, and a display included in the mobile terminal 60. The biological information of the user U may be obtained through communication between the wearable device 70 and the mobile terminal 60, and the emotion of the user U may be estimated by the mobile terminal 60 based on the biological information. The mobile terminal 60 may acquire information about the predetermined risk recognized by the ADAS 2 through communication between the in-vehicle device of the vehicle 100 and the mobile terminal 60.

When configuring the information provision system as an external communication system, for example, the image of the user U captured by the driver monitor camera 54 of the vehicle 100, speech data input to the microphone 57, and the like, as well as the information about the predetermined risk recognized by the ADAS 2 are transmitted from the vehicle 100 to the external communication system. This configuration allows the external communication system to set the emotion of the agent.

In the above embodiment, the risk recognition unit 14 is provided, and the agent control unit 13 sets the determination range which determines the emotional level of the user U according to the risk recognized by the risk recognition unit 14. As another embodiment, the risk recognition unit 14 may be omitted, and the determination range may be a preset range assuming anger, impatience, drowsiness, and the like.

Note that FIG. 2 is a schematic diagram showing the configuration of the information provision system 1 by dividing the configuration according to a main processing content to facilitate understanding of the invention of the present application, and the configuration of the information provision system 1 may be divided differently. The processing of respective components may be executed by one hardware unit or may be executed by a plurality of hardware units. The processing of each component shown in FIG. 5 may be executed by one program or may be executed by a plurality of programs.

### 5. Configurations Supported by the Above Embodiments

The above embodiments are specific examples of the following configurations.

### Configuration 1

An information provision system includes: a user state recognition unit that recognizes a state of a user in a mobile body; a user emotion estimation unit that estimates an emotional level of the user based on a predetermined index value, based on a recognition result of the state of the user by the user state recognition unit; and an agent control unit that provides, using an anthropomorphic agent, the user with a human machine interface (HMI) that performs speech output in a mode corresponding to an emotional level of the agent based on the predetermined index value, wherein the agent control unit controls the emotional level of the agent to be a target level for changing the emotional level of the user to fall outside of a predetermined determination range, when the emotional level of the user estimated by the user emotion estimation unit falls within the predetermined determination range.

According to the information provision system of Configuration 1, it is possible to suppress excessive caution, insufficient caution, or the like, when issuing a warning via the HMI using the agent to the user in the mobile body.

### Configuration 2

The information provision system according to Configuration 1 further includes a risk recognition unit that recognizes a predetermined risk faced by the mobile body, wherein the agent control unit sets the determination range according to the predetermined risk, when the predetermined risk is recognized by the risk recognition unit.

According to the information provision system of Configuration 2, it is possible to appropriately control the emotion of the agent when the agent outputs the warning speech with respect to the predetermined risk, by setting the determination range according to the type of the predetermined risk.

### Configuration 3

The information provision system according to Configuration 1 or 2, wherein the predetermined index value represents valence indicating comfort and discomfort, and the agent control unit controls the emotional level of the agent to be the target level by modifying a basic frequency or a fluctuation width of speech output by the agent, when the emotional level of the user estimated by the user emotion estimation unit falls within the predetermined determination range.

According to the information provision system of Configuration 3, it is possible to control the emotional level of the agent to be the target level by modifying the basic frequency or the fluctuation width of the speech to be output, when using the valence as the predetermined index value of the emotional level.

### Configuration 4

The information provision system according to any one of Configurations 1 to 3, wherein the predetermined index value represents valence indicating comfort and discomfort, and the agent control unit controls the emotional level of the agent to be the target level by causing an inflection of an utterance output by the agent to go up or go down, when the emotional level of the user estimated by the user emotion estimation unit falls within the predetermined determination range.

According to the information provision system of Configuration 4, it is possible to control the emotional level of the agent to be the target level by modifying the utterance speed or the sound volume of the speech to be output, when using the valence as the predetermined index value of the emotional level.

### Configuration 5

The information provision system according to any one of Configurations 1 to 4, wherein the predetermined index value represents arousal indicating excitement and calmness, and the agent control unit controls the emotional level of the agent to be the target level by modifying an utterance speed or a sound volume of speech output by the agent, when the emotional level of the user estimated by the user emotion estimation unit falls within the predetermined determination range.

According to the information provision system of Configuration 5, it is possible to control the emotional level of the agent to be the target level by modifying the utterance speed or the sound volume of the speech to be output, when using the arousal as the predetermined index value of the emotional level.

### Configuration 6

An information provision method executed by a computer includes: a user state recognition step of recognizing a state of a user in a mobile body; a user emotion estimation step of estimating an emotional level of the user based on a predetermined index value, based on a recognition result of the state of the user in the user state recognition step; and an agent control step of providing, using an anthropomorphic agent, the user with a human machine interface (HMI) that performs speech output in a mode corresponding to an emotional level of the agent based on the predetermined index value, wherein in the agent control step, the emotional level of the agent is controlled to be a target level for changing the emotional level of the user to fall outside of a predetermined determination range, when the emotional level of the user estimated in the user emotion estimation step falls within the predetermined determination range.

It is possible to achieve advantageous effects similar to those of the information provision system of Configuration 1 through a computer executing the information provision method of Configuration 6.

### Configuration 7

A non-transitory computer-readable storage medium storing a program causes a computer to function as: a user state recognition unit that recognizes a state of a user in a mobile body; a user emotion estimation unit that estimates an emotional level of the user based on a predetermined index value, based on a recognition result of the state of the user by the user state recognition unit; and an agent control unit that provides, using an anthropomorphic agent, the user with a human machine interface (HMI) that performs speech output in a mode corresponding to an emotional level of the agent based on the predetermined index value, wherein the agent control unit controls the emotional level of the agent to be a target level for changing the emotional level of the user to fall outside of a predetermined determination range, when the emotional level of the user estimated by the user emotion estimation unit falls within the predetermined determination range.

It is possible to achieve the configuration of the information provision system of Configuration 1 through a computer executing the program of Configuration 7.

### REFERENCE SIGNS LIST

1: information provision system
2: ADAS
10: processor
11: user state recognition unit
12: user emotion estimation unit
13: agent control unit
14: risk recognition unit
20: memory
21: program
22: emotion map
30: communication unit
50: front camera
51: speed sensor
52: gyro sensor
53: GNSS sensor
54: driver monitor camera
55: display
56: speaker
57: microphone
60: mobile terminal
70: wearable device
100: vehicle (mobile body)
200: communication network
210: content server
U: user

1. An information provision system comprising:
a user state recognition unit that recognizes a state of a user in a mobile body;
a user emotion estimation unit that estimates an emotional level of the user based on a predetermined index value, based on a recognition result of the state of the user by the user state recognition unit; and
an agent control unit that provides, using an anthropomorphic agent, the user with a human machine interface (HMI) that performs speech output in a mode corresponding to an emotional level of the agent based on the predetermined index value, wherein
the agent control unit controls the emotional level of the agent to be a target level for changing the emotional level of the user to fall outside of a predetermined determination range, when the emotional level of the user estimated by the user emotion estimation unit falls within the predetermined determination range.

2. The information provision system according to claim 1, further comprising a risk recognition unit that recognizes a predetermined risk faced by the mobile body, wherein
the agent control unit sets the determination range according to the predetermined risk, when the predetermined risk is recognized by the risk recognition unit.

3. The information provision system according to claim 1, wherein
the predetermined index value represents valence indicating comfort and discomfort, and
the agent control unit controls the emotional level of the agent to be the target level by modifying a basic frequency or a fluctuation width of speech output by the agent, when the emotional level of the user estimated by the user emotion estimation unit falls within the predetermined determination range.

4. The information provision system according to claim 1, wherein
the predetermined index value represents valence indicating comfort and discomfort, and
the agent control unit controls the emotional level of the agent to be the target level by causing an inflection of an utterance output by the agent to go up or go down, when the emotional level of the user estimated by the user emotion estimation unit falls within the predetermined determination range.

5. The information provision system according to claim 1, wherein
the predetermined index value represents arousal indicating excitement and calmness, and
the agent control unit controls the emotional level of the agent to be the target level by modifying an utterance speed or a sound volume of speech output by the agent, when the emotional level of the user estimated by the user emotion estimation unit falls within the predetermined determination range.

6. An information provision method executed by a computer, the information provision method comprising:
a user state recognition step of recognizing a state of a user in a mobile body;
a user emotion estimation step of estimating an emotional level of the user based on a predetermined index value, based on a recognition result of the state of the user in the user state recognition step; and
an agent control step of providing, using an anthropomorphic agent, the user with a human machine interface (HMI) that performs speech output in a mode corresponding to an emotional level of the agent based on the predetermined index value, wherein
in the agent control step, the emotional level of the agent is controlled to be a target level for changing the emotional level of the user to fall outside of a predetermined determination range, when the emotional level of the user estimated in the user emotion estimation step falls within the predetermined determination range.

7. A non-transitory computer-readable storage medium storing a program for causing a computer to function as:
a user state recognition unit that recognizes a state of a user in a mobile body;
a user emotion estimation unit that estimates an emotional level of the user based on a predetermined index value, based on a recognition result of the state of the user by the user state recognition unit; and
an agent control unit that provides, using an anthropomorphic agent, the user with a human machine interface (HMI) that performs speech output in a mode corresponding to an emotional level of the agent based on the predetermined index value, wherein
the agent control unit controls the emotional level of the agent to be a target level for changing the emotional level of the user to fall outside of a predetermined determination range, when the emotional level of the user estimated by the user emotion estimation unit falls within the predetermined determination range.
